(19) United States
(12) Patent Application Publication
(10) Pub. No.: US 2019/0249565 A1
(43) Pub. Date: Aug. 15, 2019

(54) METHOD FOR DETECTING DAMAGE DURING THE OPERATION OF A GAS TURBINE

(71) Applicant: Siemens Aktiengesellschaft, Munich (DE)

(72) Inventors: Fabian Luck, Berlin (DE); Uwe Pfeifer, Berlin (DE)

(73) Assignee: Siemens Aktiengesellschaft, Munich (DE)

(21) Appl. No.: 16/333,391

(22) PCT Filed: Aug. 16, 2017
(86) PCT No.: PCT/EP2017/070700

§ 371 Date: Mar. 14, 2019

(30) Foreign Application Priority Data
Sep. 23, 2016 (EP) 16190374.5

(51) Int. Cl. F01D 21/12

(52) U.S. Cl. CPC F01D 21/12; F05D 2270/3032; F05D 2270/112; F05D 2260/80

(57) ABSTRACT

A method for detecting damage during the operation of a gas turbine, including the following steps: calculating an average value of individual temperature measurement values over a defined sampling time period from an ensemble of temperature sensors in or on the gas turbine; calculating the individual temperature differences between the average value and the individual temperature measurement values over the defined sampling time period; calculating the individual temperature differences for successive sampling time periods over a defined time interval; creating a first distribution by dividing the temperature differences associated with a temperature sensor for the defined time interval into temperature difference intervals; comparing the first distribution with a second distribution of temperature differences likewise divided into temperature difference intervals; and producing an operation signal on the basis of a negative result of the comparison.

### CROSS REFERENCE TO RELATED APPLICATIONS

This application is the US National Stage of International Application No. PCT/EP2017/070700 filed Aug. 16, 2017, and claims the benefit thereof. The International Application claims the benefit of European Application No. EP16190374 filed Sep. 23, 2016. All of the applications are incorporated by reference herein in their entirety.

### FIELD OF INVENTION

The present invention relates to a method for detecting damage during the operation of a gas turbine and to such a gas turbine, as well as to a control device which is configured in order to carry out a corresponding method.

### BACKGROUND OF INVENTION

Methods for detecting damage during the operation of a gas turbine are already known from US 2004/079070 A1 and US 2004/086024 A1. A control device for a turbine is known for example from US 2012/194667.

In gas turbines, various types of damage can occur because of heat. In gas turbines, for instance, the thermally most greatly loaded region, the so-called hot gas region, is exposed to temperatures of up to 1600° C. If there is then damage in the hot gas region, particularly at the burners or tubular combustion chambers of a gas turbine, it may often be observed that this damage does not occur suddenly but appears and develops over a prolonged period of time.

Often, an inhomogeneous temperature distribution inside the gas turbine gives rise to this thermally induced damage. In a gas turbine, for instance, in the event of burner damage the turbine blades very strongly experience alternating thermal loads, since because of their rotation they are exposed to the different thermal conditions in the burner. With an increasing operating time, this alternating load structurally damages the blades of a gas turbine. The greater the temperature differences to which the component parts are exposed during alternating loads are, the more rapidly the component parts age and have to be replaced because of damage.

Not only the alternating thermal load, but also static thermal stresses may lead to material failure in the vicinity of the damaged positions inside the gas turbine. If, for instance, the burners or the tubular combustion chambers in a gas turbine are damaged, as a result thermal material failure in the region of the so-called transition may often be observed. This material failure is typically preceded by damage to the ceramic coating with which the transitions are provided. After failure of this ceramic coating, consequent failure of the metallic base structure of the transition often occurs. As a result of the unfavorable thermal loading of these components, microcracks or other material-technological damage of the individual components may occur over prolonged operating periods. Such microcracks develop in the course of the further operating time to form macroscopic cracks, through which for instance cold cooling air may enter the combustion chamber, which in turn leads to a lowering of the combustion chamber temperature. The thus lowered exit temperature of the hot gas at the respectively affected burner locally propagates after passing through all the turbine stages in an increasingly attenuated form, but may still be detected significantly in terms of measurement technology as a cold air stream in the region of the flue gas exit channel of the gas turbine.

In order to be able to record such damage events by measurement technology, temperature sensors (thermocouples) are often used in gas turbines, which can record differences in the thermal loads of the gas turbine, or of the components which it comprises. In gas turbines about twelve to twenty-four temperature sensors are distributed radially in the region of the flue gas exit channel, and thus allow polar flue gas temperature measurement. Previously used methods for recording such thermal damage events have for instance required lowpass filtering of the temperature measurement values, or a comparison calculation of some of the temperature measurement values recorded by the temperature sensors.

In this case, however, it has been found that thermally induced damage cannot be detected sufficiently promptly and reliably, for which reason there is a need for a further method in order to be able to evaluate the temperature measurement values measured with the temperature sensors, in order to be able to carry a secure and reliable prediction. For the operator of a gas turbine, it is desirable to detect such thermal damage as early as possible, in order to obtain improved plannability of the servicing measures as well as plannability of turning off the gas turbine in the event of a maintenance repair. Furthermore, the operator of such a gas turbine will want to prevent total damage so as to be able to avoid consequent damage to other components inside the gas turbine.

The known current evaluation methods for analyzing the temperature measurement values provide only unreliable and therefore insufficient results because of the wide variance of the results. Consequently, the thermal damage often cannot be detected sufficiently early. Furthermore, there is also a natural stochastic variance in the temperature measurement values recorded, which may lead to further concealment of possible thermal damage.

There is therefore a technical need to propose a further method, or a suitable control device for carrying out such a method, or a corresponding gas turbine, which can avoid the disadvantages known from the prior art. In particular, the intention is to propose a method or a control device, as well as a gas turbine, which allows secure and reliable early detection of thermal damage events.

### SUMMARY OF INVENTION

An object of the invention is achieved by a method, as well as by a control device and a gas turbine as claimed.

In particular, the object of the invention is achieved by a method for detecting damage during the operation of a gas turbine, comprising the following steps: —calculation of an average value of individual temperature measurement values over a predetermined sampling period of an ensemble of temperature sensors in or on the gas turbine, —calculation of the individual temperature differences between the average value and the individual temperature measurement values over the predetermined sampling period, —calculation of the individual temperature differences for chronologically successive sampling periods over a predetermined time interval, —compilation of a first distribution by dividing the temperature differences assigned to one temperature sensor for the predetermined time interval into temperature difference intervals, —comparison of the first distribution with a second distribution of temperature differences likewise divided into temperature difference intervals, —generation of an operating signal on the basis of a negative outcome of the comparison.

The objects of the invention are furthermore achieved by a control device which is configured in order to carry out the method described above as well as below, a calculation unit being contained which carries out the calculation of the average value of the individual temperature measurement values, the calculation of the individual temperature differences, the compilation of a first distribution and of a second distribution, and the comparison of the first distribution with a second distribution, as well as a signal generation unit which generates an operating signal in the event of a negative outcome of the comparison.

The objects of the invention are furthermore achieved by a gas turbine which comprises a control device as described above as well as below.

At this point, it should be mentioned that the present distributions are to be understood in the sense of a frequency distribution.

The aforementioned sampling period in this case corresponds to an inverse sampling rate according to which, in the present case, a temperature difference is calculated for example once per second. What is essential is that the sampling period is shorter than a period over which the gas turbine is typically operated before damage occurs. In other words, the sampling period should on the one hand be sufficiently short in order to achieve a time resolution which is as good as possible, but on the other hand should not be too short so as to avoid unnecessary recording of data which subsequently also need to be temporarily stored. Typical sampling periods lie in the range of seconds to minutes.

According to the invention, the present time intervals are not shorter than the sampling periods, but in one case these may even correspond. Typically, however, the time intervals are significantly longer, so that many sampling periods may lie in one time interval. The time intervals must be selected to be large enough so that the development of the thermal damage over time can be observed sufficiently well. Typical time intervals lie in the range of days, weeks or even months.

At this point, it should be mentioned that the temperature difference intervals are to be understood in the sense of numerical intervals into which the temperature differences can be sorted according to value, in order to obtain corresponding division of a distribution. In other words, the temperature difference intervals are nothing other than numerical ranges that have been defined beforehand, by means of which a frequency distribution is intended to be calculated. In the normal case, the numerical intervals are contiguous, so an interval can be assigned to each temperature difference. In particular, for technical calculation reasons, the numerical intervals are in this case selected to be equidistant, so that an adjacent interval in each case extends over a comparable interval length. In the present gas turbines, it has proven favorable to select the adjacent intervals at between 0.1 kelvin and approximately 4 kelvin in terms of their interval width. If the frequencies of individual temperature differences in the determined numerical intervals are then subsequently counted and compared with the total number of all entries, a frequency distribution in the sense of the present distribution can be calculated easily.

In a gas turbine according to the invention, the temperature sensors may advantageously be arranged in the region of the flue gas exit channel. Arrangement of the temperature sensors with a radial geometry, in order to record a polar temperature image, is also advantageous.

According to the invention, an operating signal should be generated on the basis of a negative outcome of the comparison. There is a negative outcome if, from the outcome of the comparison, the knowledge can be obtained that a damage event has occurred, or such a damage event is impending and will happen in the future. In this case, particular limit values must typically be determined beforehand, the exceeding or reaching of which can be classified as a negative outcome. Such limit values are typically defined with the aid of empirical values. Different limit values may also be predetermined in this case, depending on the component part in question of the gas turbine. Global predetermination of such limit values is not expedient.

According to the invention, provision is made to carry out the damage detection on the basis of the comparison of two distributions. The distributions are in this case compiled beforehand for respective temperature sensors and, for instance, make it possible to specify the time variation of the deviations of individual temperature measurement values from the average value of the individual temperature measurement values. Thus, instead of considering individual absolute values of the temperature sensors, as previously conventional, according to the invention individual distributions of the temperature measurement values are now considered, which have been recorded over a predetermined time interval. The resolution of the distribution is in this case determined by the sampling periods, and may be adjusted individually according to requirements.

Because of the comparison of individual distributions, the previously described problems relating to the variance of individual temperature measurement values can now be reduced, since entire distributions that have been derived from many temperature measurement values are compared. The comparison of two distributions may in this case in turn be carried out in different ways, and is the subject-matter of the subsequent dependent claims. After carrying out a simple numerical calculation, however, it has been found that the comparison from the distributions is far superior to a comparison of individual temperature measurement values.

If it is then revealed by such a comparison that a particular negative outcome can be derived, an operating signal is generated for the operator of the gas turbine, which may entail a power reduction, turning off in one or more sections, or else shutdown of the entire gas turbine.

According to a first advantageous embodiment of the invention, it is provided that the second distribution relates to temperature differences of the same temperature sensor, which are divided into the same temperature difference intervals but which were calculated for a different time interval. Consequently, the time variation of the distribution of a temperature sensor can thus be followed and conclusions can thus be drawn about time variations in the local region of the temperature sensor. If it is thus found, for instance, that a significant change of the second distribution has taken place at a chronologically subsequent time interval, this may be an indication of the presence of a negative outcome. Thus, for instance, it may be established at a predetermined temperature sensor that a variation of the second distribution has taken place, so that for instance thermal damage in the combustion chamber region could be deduced.

According to another embodiment of the invention, it is provided that the comparison of the first distribution with the second distribution is carried out by a comparison of the maximum of the first distribution with the maximum of the second distribution. Comparison of the maxima is in this case relatively straightforwardly possible since only single numerical values need to be compared with one another. It is thus not necessary to set the entire distribution width of the first distribution and second distribution in relation to one another, rather it is merely sufficient to compare the numerical values of the maxima with one another in order to be able to make a statistically significant statement. Calculation can thus be carried out rapidly and simply.

According to another embodiment of the invention, it is provided that the comparison of the first distribution with the second distribution is carried out by plotting the two distributions in a common diagram with an axis representing the time profile over the two time intervals. By the graphically represented change of the profile of the distributions, it is likewise possible to identify when the distribution change shows or predicts damage. Particularly suitable in this case are color value histograms, which with the aid of the color values allow a numerical value range to be identified and thus, by means of changes of the color values, also makes possible to draw conclusions about changes of the numerical values. The color values allow a visually readily accessible distribution representation, as well as identification of distribution changes as a function of time. Such color value histograms may, for example, be displayed by the operator of the gas turbine for the individual temperature sensors, so that he can check the regions at which temperature sensors have been fitted.

According to another embodiment of the method according to the invention, it is provided that the comparison of the first distribution with the second distribution is carried out by a comparison of the position of the maximum of the first distribution with the boundaries of a state space, which state space has been determined from the distribution width of the second distribution. Because of its width, the second distribution thus specifies a state space, i.e. a value band, within which the first maximum should lie in the case of an intact gas turbine. The state space is in this case obtained from empirical values, i.e. measurement values over a length of the time interval, the state space being derived from the distribution width of the second distribution. In particular, the three-sigma width of the second distribution may be employed as a state space. Once the distribution width of the second distribution is determined, for instance beforehand by evaluating a large number of temperature measurement values, it is possible to check easily whether or not the maximum of the first distribution falls within the state space of the second distribution. There would, for instance, be a negative outcome if the maximum of the first distribution is located outside the state space of the second distribution. Carrying out this numerical comparison is relatively simple and easy to accomplish.

According to another aspect of the present invention, it is provided that the first distribution and/or the second distribution are calculated cumulatively from all sampling periods of the time intervals. The cumulative calculation increases the statistical meaningfulness, since increasingly more distribution values can be added to the distributions respectively already determined beforehand, so as to successively compile an ever-more accurate distribution. However, such a cumulative calculation shows only minor changes of relatively long time intervals, so that the time intervals should be selected to be correspondingly short so as to avoid concealment of impending thermal damage.

As an alternative or even in addition, it can be provided that the second distribution may be derived from the first distribution by a sliding calculation over the first time interval. The second distribution is thus obtained from the first distribution by determining the second time interval to be correspondingly longer than the first time interval and at least partially overlapping therewith. This form of sliding calculation also allows a simple possibility, particularly in the case of graphical representation on a screen and continuous updating of the distributions, to record variations in the first distribution. If the second distribution is still identical to the first distribution for the first time interval, or parts thereof, after a continued sliding calculation a deviation may possibly occur, from which a negative outcome of the comparison may be derived.

According to another advantageous embodiment of the invention, it is provided that the second distribution relates to temperature differences of a different temperature sensor, which are divided into temperature difference intervals but which were calculated for the same time interval. To this extent, as it were, different temperature sensors are evaluated with the same evaluation method over the same measurement period. If, for instance, the temperature sensors are arranged in such a way that their temperature environment is comparable, comparable distributions are also to be expected over prolonged operating periods. These allow usual aging phenomena to be understood. If, however, the distributions deviate from one another beyond a certain point in time, this may be an indication of damage. Particularly in the case of temperature sensors which, in thermal terms, are intended to be exposed to a geometrical different position but thermally identical conditions it is thus rapidly possible to determine a match of the temperature sensors or thermal damage which can be correlated with a particular temperature sensor.

According to one refinement of this idea, the comparison of the first distribution with the second distribution is carried out by a comparison of the maximum of the first distribution with the maximum of the second distribution. As already mentioned above, comparison of the maxima is relatively simply possible since only two numerical values need to be compared with one another. The calculation for the comparison is thus relatively simple to accomplish, and likewise a negative outcome can be derived rapidly from this calculation.

According to one additional refinement of this approach, the comparison of the maxima applies for all maxima of the temperature sensors of the ensemble, so that the ensemble difference between the greatest and smallest maximum from the ensemble is determined. By comparison of the individual maxima over all the temperature sensors, it is thus possible to determine a temperature variance field within which the maximum determined temperature differences are given. From the spread of the individual maxima, a measure is also obtained for the alternating thermal loading which the relevant application positions of the temperature sensors in the gas turbine experience. In the case of rotating hot-gas component parts, this allows conclusion to be drawn about the thermal loading of these components parts. Specifically, the rotating hot-gas component parts are exposed continuously to alternating thermal loading which is commensurately greater when the spread of all the maxima is greater. In other words, the alternating thermal loading is commensurately all the greater when the largest maximum deviates more strongly from the smallest maximum.

The invention will be described in more detail below with reference to the individual figures. In this case, it is to be mentioned that the technical features provided with the same references in the figures are intended to have the same technical function.

It should likewise be mentioned that the technical features described in the following figures are intended to be claimed in any desired combination with one another, and also in any desired combination with the embodiments of the invention which have been presented above, so long as the combination resulting therefrom can achieve the object of the invention.

It should furthermore be meant that the following figures are to be understood as merely schematic, and in particular do not offer any indication of a supposed restriction of the implementability of the invention.

### BRIEF DESCRIPTION OF THE DRAWINGS

In the figures:

FIG. 1 shows a diagrammatic representation of a first frequency distribution D₁ of individual temperature difference values for a predetermined time interval in temperature difference intervals dT_{i,j};

FIG. 2 shows a diagrammatic representation of the first frequency distribution D₁ shown in FIG. 1 with indication of the frequency maximum Max₁ at a temperature of −4.0 K (=dT_{Max1});

FIG. 3 shows a color value histogram of a chronological representation of the variation of individual distributions as a function of time t;

FIG. 4 shows a diagrammatic representation of the ratios of the position of the first frequency maximum Max₁ (or Max₁′) of the first distribution with the state space Z derived from the second distribution for different powers P of the gas turbine;

FIG. 5 shows a diagrammatic representation of the variance of the maxima Maxᵢ for an ensemble of temperature sensors, respectively for a predetermined time interval;

FIG. 6 shows a diagrammatic representation of the variance of the maxima Maxᵢ of temperature sensors of an ensemble of temperature sensors as shown in FIG. 5, but with a much smaller spread; and

FIG. 7 shows a flowchart representation of one embodiment of the method according to the invention for detecting damage during the operation of a gas turbine.

### DETAILED DESCRIPTION OF INVENTION

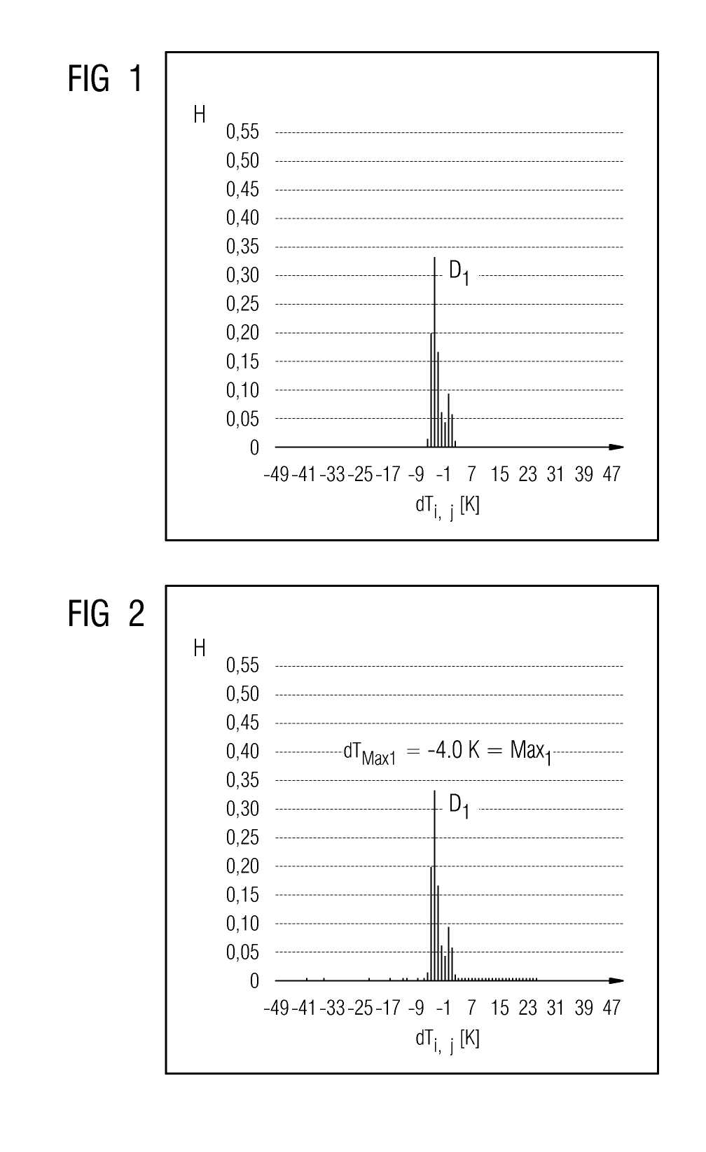

FIG. 1 shows a diagrammatic representation of a first frequency distribution D₁, which has been normalized. The ordinate therefore corresponds to a unitless relative frequency H. As can be seen, the frequency distribution D₁ has a distribution width of about 10 K, a clear maximum being formed at a different temperature dT of about −4 K. The first distribution D₁ was compiled by calculating a predetermined number of temperature differences ΔT_{i,k} for chronologically successive sampling periods tₖ over a predetermined time interval dt₁ and correspondingly dividing a temperature difference interval dT into individual numerical intervals dT_{i,j}. After corresponding normalization and matching of the temperature to a predetermined zero value, the represented first distribution D₁ is obtained.

At this point, it should be mentioned that the preceding and following indices i and m range from 1 to the number of temperature sensors of the ensemble in question. If individual sensors are picked out by way of example, the indices are indicated explicitly, for example by 1 or 2. The index k furthermore ranges from 1 to the number of sampling periods which lie within a time interval dt. This may be just one sampling period, or significantly more, for instance even of the order of 10⁶ or more. The index j relates to the number of individual temperature difference intervals for a distribution. In this case, the index j typically lies between 1 and less than 1000.

According to one embodiment of the method according to the invention, the represented first distribution D₁ may then furthermore be compared with a second distribution D₂, the second distribution D₂ likewise having temperature differences ΔT_{i,k} divided into temperature difference intervals dT. If there is a deviation during the comparison of the first distribution D₁ with the second distribution D₂, a negative outcome of the comparison may possibly be deduced, an operating signal being generated on the basis thereof and the operator of the gas turbine for instance being informed that a thermal damage event will occur in the future, or has already occurred.

FIG. 2 shows the first distribution D₁, as already represented in FIG. 1, but now with an indicator of the maximum of the first distribution D₁. Since the temperature values have been matched to a zero value, the present distribution shows a maximum value dT_{Max1}=Max₁ of −4 K. According to the embodiment, this maximum value Max₁ may be used for a further comparison of the first distribution D₁ with the second distribution D₂. In this case, for example, as explained above, the maximum values Max₁ and Max₂ (=dT_{Max2}) of the two distributions D₁ and D₂ may be compared with one another, or alternatively a correspondence of the maximum value Max₁ with a state space Z which has been derived from the distribution width of the second distribution D₂.

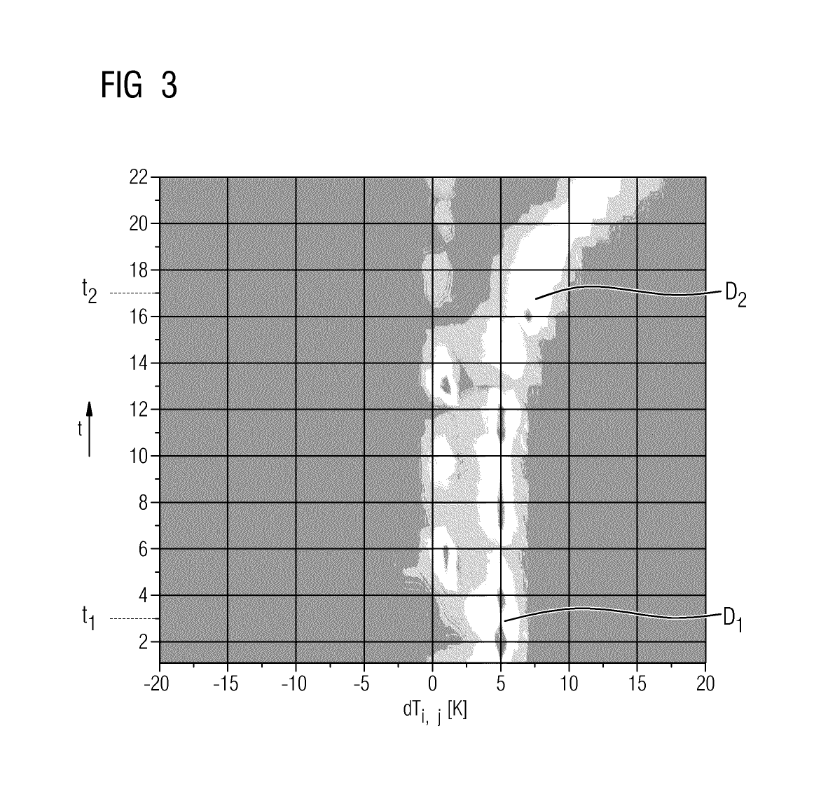

FIG. 3 shows a color value histogram of individual distributions in a time profile. In this case, the distributions D divided into temperature difference intervals dT are plotted against the time t. The time t is itself given by continuous representation of individual time intervals dt which follow one another. Typically, the time axis has the unit of weeks. The present case thus shows the time profile of the temperature differences ΔT_{i,k} divided into temperature difference intervals dT_{i,j} over a total time of 22 weeks. The time intervals dt in this case have a length which is not further specified. If, however, the first distribution D₁ is taken at the time of three weeks, it is found that the distribution has a maximum in the range of about +5 K. Changes of this maximum value of the distribution D₁, for instance at a time of five and a half weeks, may be explained by different operating conditions of the gas turbine in partial load. Thermal damage, however, may be ruled out in this case.

If, however, a distribution is considered in the sense of a second distribution D₂ at the time of 17 weeks, it is found that the distribution has been shifted toward larger temperature difference interval values dT_{i,j}. The maximum of the distribution is now only at about 7.5 K. This condition results because of damage to the combustion turbine components in the gas turbine. In other words, a change which can visually be identified easily can be seen clearly from the difference of the first distribution D₁ and the second distribution D₂, both of which have been generated from the division of different temperature differences ΔT_{i,k} of a temperature sensor Sᵢ for equal temperature difference intervals dT_{i,j}. This deviation of the two distributions D₁ and D₂ continues to increase from the seventh week to the twenty-second week. At the twenty-second week, the operator of the gas turbine in question could then infer failure of the gas turbine because of damage to the hot-gas components in the combustion chamber. This damage event at the twenty-second week, however, could already have been foreseen from the sixteenth week. By continuous monitoring of the temperature measurement values, or by suitable evaluation as proposed in the scope of the present invention, a future damage event can easily be predicted with the aid of the visual as well as numerical deviations of the calculated individual distributions.

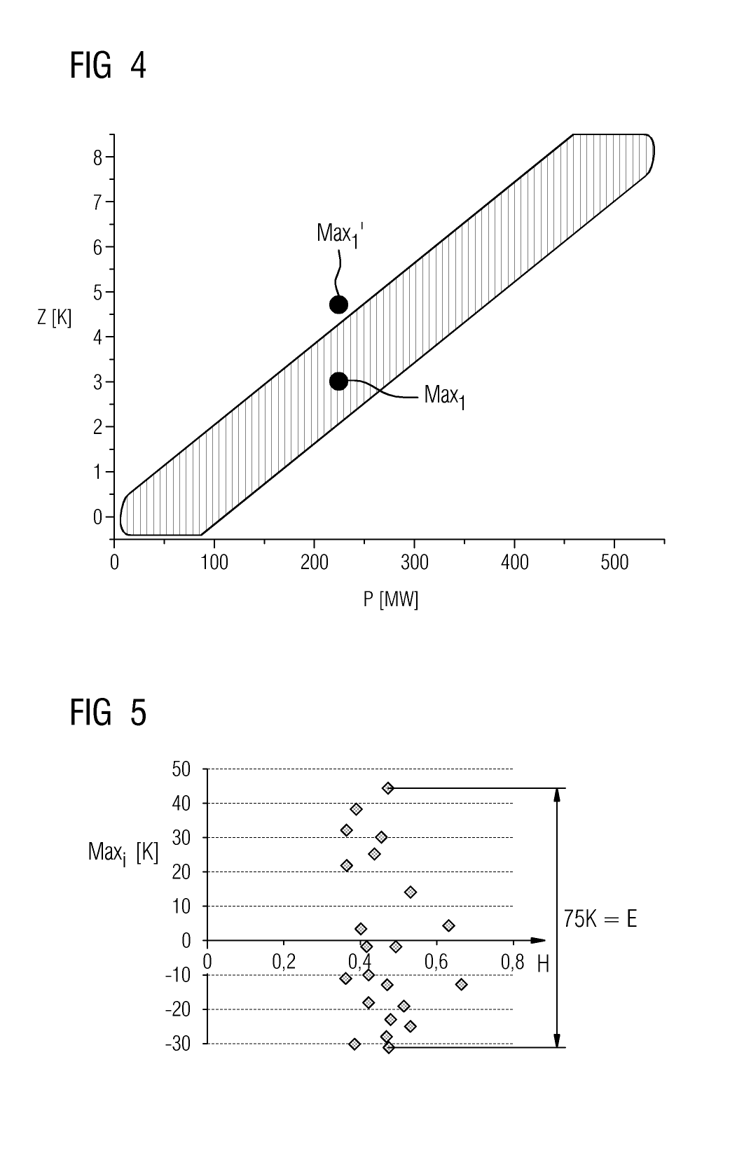

FIG. 4 shows a diagrammatic representation of a visual comparison between the maximum value Max₁ (or Max₁′) of the first distribution D₁ in comparison with a distribution width, the state space Z, derived from the second distribution D₂. In this case, the distribution width is plotted as a function of the power P of the gas turbine. As can be understood clearly, although this distribution width does not increase with increasing power, it is however shifted linearly toward higher temperature values. As already noted above, it is known that, in the event of different loads of the gas turbine, different temperatures also occur during the combustion, and particularly for gas turbines it is for instance known that the combustion chamber temperature also changes with an increasing load according to certain operating methods.

The comparison of the first maximum Max₁ of the first distribution D₁ with the state space Z of the second distribution D₂ is carried out at a power of about 215 MW. As can be clearly seen, the maximum value Max₁ lies inside the shaded region of the marked state space Z. In other words, the deviation of the first distribution D₁ from the second distribution D₂, which in the present case is not explicitly shown but would be made pictorially representable with the aid of the state space, is sufficiently corresponding. Damage to the hot-gas parts of the gas turbine can therefore substantially be ruled out.

The situation, however, is different with the maximum value Max₁′ likewise represented in the diagram, which is intended to represent approximately the maximum value of another first distribution D₁. As can be seen easily, this alternative maximum value Max₁′ does not fall within the gray-shaded region and therefore lies outside the state space Z of the second distribution D₂. This circumstance may now be rated as a negative outcome of the comparison of the two distributions D₁ and D₂, and may lead to the generation of an operating signal. On the basis of the deviation of the values, the operator may then infer that a possible thermal damage event has occurred.

FIG. 5 shows a representation of all maxima Maxᵢ (=dT_{Maxi}) of an ensemble of temperature sensors Sᵢ. Overall, the maxima Maxᵢ of 24 temperature sensors Sᵢ are represented, the spread comprising about 75 K. The spread corresponds to the ensemble difference E, which may be used as a reference quantity for future comparisons.

It should be mentioned that the maxima shown have again been subjected to a zero-value match, that is to say the maximum values have been reduced by a constant factor to the extent that they spread around 0 K. These technical diagrammatic simplifications are merely used for improved representation.

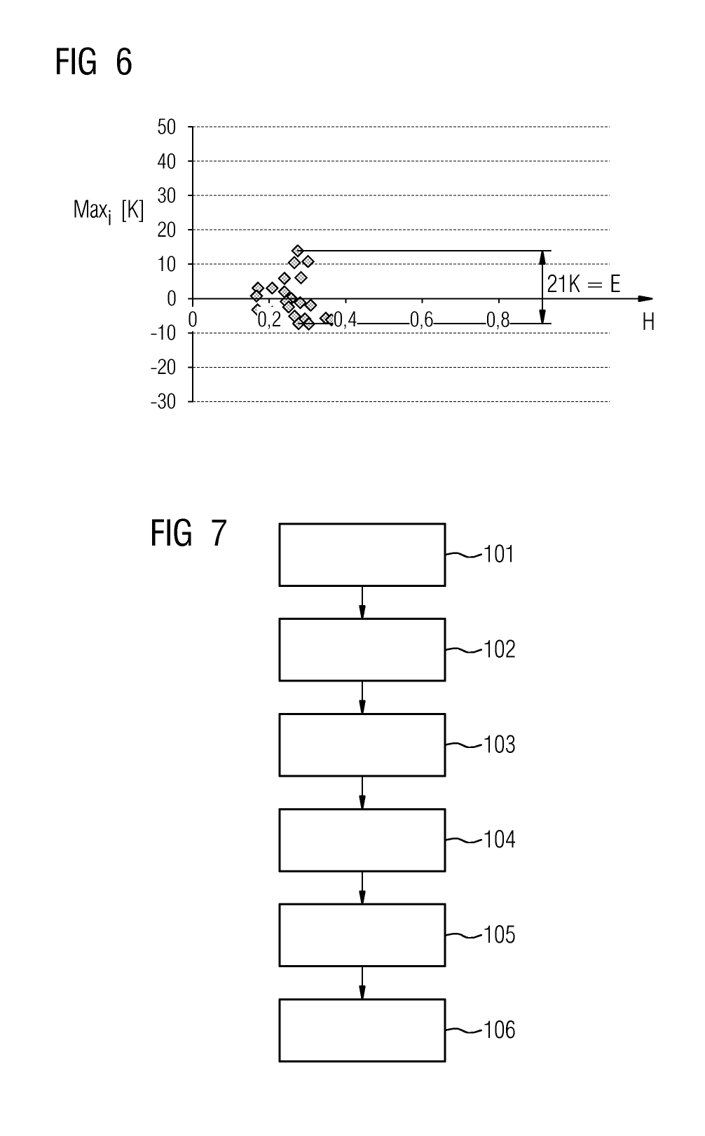

FIG. 6 shows in comparison to FIG. 5 a diagram of a number of maxima Maxᵢ of the same ensemble of temperature sensors Sᵢ, the spread now being much smaller and lying at 21 K. By a comparison of the ensemble difference E of the two representations, it can now be seen that there are less great thermal deviations according to the operating state according to FIG. 6 within the gas turbine in question. Particularly in gas turbines with moving or rotating components, for instance the rotor, it can therefore be assumed that the moving components are exposed to increased alternating thermal stress.

If the maxima Maxᵢ shown are derived for instance from temperature sensors which are arranged radially in the flue gas exit channel of the gas turbine, it may be inferred from the greater spread according to FIG. 5 that, in particular, the rotating turbine blades are subject to a stronger alternating thermal stress during their movement. This in turn makes possible to deduce that the thermally loaded components are subjected to a more rapid aging process and therefore need to be serviced or replaced earlier. If it is then found in the course of operation that the spread of some maxima Maxᵢ increases very greatly, or the ensemble difference E changes significantly, this may be evaluated as a negative outcome and the operator of the gas turbine may be informed that a servicing measure should be carried out in some way.

FIG. 7 shows a flowchart representation of one embodiment of the method according to the invention for detecting damage during the operation of a gas turbine, which comprises the following steps: —calculation of the average value T_{avg,k} of individual temperature measurement values T_{i,k} over a predetermined sampling period tₖ of an ensemble of temperature sensors Sᵢ in or on the gas turbine 1 (first method step 101); —calculation of the individual temperature differences ΔT_{i,k} between the average value T_{avg,k} and the individual temperature measurement values T_{i,k} over the predetermined sampling period tₖ (second method step 102); —calculation of the individual temperature differences ΔT_{i,k} for chronologically successive sampling periods tₖ over a predetermined time interval dt₁ (third method step 103); —compilation of a first distribution D₁ by dividing the temperature differences ΔT_{i,k} assigned to one temperature sensor Sᵢ for the predetermined time interval dt₁ into temperature difference intervals dT_{i,j} (fourth method step 104); —comparison of the first distribution D₁ with a second distribution D₂ of temperature differences ΔT_{i,k} likewise divided into temperature difference intervals dT_{i,j} (fifth method step 105); —generation of an operating signal on the basis of a negative outcome of the comparison (sixth method step 106).

Further embodiments may be found in the dependent claims.

1. A method for detecting damage during operation of a gas turbine, comprising:
calculation of an average value (T_{avg,k}) of individual temperature measurement values (T_{i,k}) over a predetermined sampling period (tₖ) of an ensemble of temperature sensors (Sᵢ) in or on the gas turbine,
calculation of the individual temperature differences (ΔT_{i,k}) between the average value (T_{avg,k}) and the individual temperature measurement values (T_{i,k}) over the predetermined sampling period (tₖ),
calculation of the individual temperature differences (ΔT_{i,k}) for chronologically successive sampling periods (tₖ) over a predetermined first time interval (dt₁),
compilation of a first distribution (D₁) by dividing the temperature differences (ΔT_{i,k}) assigned to one temperature sensor (Sᵢ) for the predetermined first time interval (dt₁) into temperature difference intervals (dT_{i,j}),
comparison of the first distribution (D₁) with a second distribution (D₂) of temperature differences (ΔT_{i,k}) likewise divided into temperature difference intervals (dT_{i,j}), and
generation of an operating signal on the basis of a negative outcome of the comparison.

2. The method as claimed in claim 1,
wherein the second distribution (D₂) relates to temperature differences (ΔT_{i,k}) of the same temperature sensor (Sᵢ), which are divided into the same temperature difference intervals (dT_{i,j}) but which were calculated for a second time interval (dt₂).

3. The method as claimed in claim 1,
wherein the comparison of the first distribution (D₁) with the second distribution (D₂) is carried out by a comparison of the maximum (Max₁) of the first distribution (D₁) with the maximum (Max₁) of the second distribution (D₂).

4. The method as claimed in claim 2,
wherein the comparison of the first distribution (D₁) with the second distribution (D₂) is carried out by plotting the two distributions (D₁, D₂) in a common diagram with an axis representing a time profile over the first and second time intervals (dt₁, dt₂).

5. The method as claimed in claim 1,
wherein the comparison of the first distribution (D₁) with the second distribution (D₂) is carried out by a comparison of the position of the maximum (Max₁) of the first distribution (D₁) with the boundaries of a state space (Z) which has been determined from a distribution width of the second distribution (D₂).

6. The method as claimed in claim 2,
wherein the first distribution (D₁) and/or the second distribution (D₂) are calculated cumulatively for all sampling periods (tₖ) of the first and second time intervals (dt₁, dt₂).

7. The method as claimed in claim 1,
wherein the second distribution (D₂) is derived from the first distribution (D₁) by a sliding calculation over the first time interval (dt₁).

8. The method as claimed in claim 1,
wherein the second distribution (D₂) relates to temperature differences (ΔT_{m,k}) of a different temperature sensor (Sₘ), which are divided into temperature difference intervals (dT_{m,j}) but which were calculated for the first time interval (dt₁).

9. The method as claimed in claim 8,
wherein the comparison of the first distribution (D₁) with the second distribution (D₂) is carried out by a comparison of the maximum (Max₁) of the first distribution (D₁) with the maximum (Max₁) of the second distribution (D₂).

10. The method as claimed in claim 9,
wherein the comparison of the maxima (Max₁) applies for all maxima of the temperature sensors (Sᵢ) of the ensemble, so that the ensemble difference (E) between the greatest and smallest maximum (Max₁) from the ensemble is determined.

11. A control device which is configured in order to carry out the method as claimed in claim 1, comprising:
a calculation unit being contained which carries out the calculation of the average value (T_{avg,k}) of the individual temperature measurement values (T_{i,k}), the calculation of the individual temperature differences (ΔT_{i,k}), the compilation of a first distribution (D₁) and of a second distribution (D₂), and the comparison of the first distribution (D₁) with a second distribution (D₂), as well as a signal generation unit which generates an operating signal in the event of a negative outcome of the comparison.

12. A gas turbine, comprising:
a control device as claimed in claim 11.
